(19) United States
(12) Patent Application Publication
(10) Pub. No.: US 2006/0056761 A1
(43) Pub. Date: Mar. 16, 2006

(54) OPTICAL SWITCH

(76) Inventor: Todd Clifford Sicklinger, Jersey City, NJ (US)

Correspondence Address: TODD SICKLINGER, 35 RIVER DRIVE #1111, JERSEY CITY, NJ, 07310, US

(21) Appl. No.: 10/711,374

(22) Filed: Sep. 14, 2004

(51) Int. Cl. G02B 6/35

(52) U.S. Cl. 385/16

(57) ABSTRACT

This application discloses an optical switch that uses a plasma field to alter the path of the light.

### FIELD OF THE INVENTION

The disclosed invention is directed to the field of optical switches.

### BACKGROUND

Light signals are used for a variety of applications including communications applications. The light signals are generally transmitted through the use of waveguides. Optical switches are used to alter the path of such Light signals from one waveguide to another waveguide. There has been a long felt need to provide a low cost, high speed, low energy consuming, high reliability optical switch.

A variety of types of optical switches are currently in use. These prior art optical switches include switches that accomplish their function by converting the optical signal into an electrical single and subsequently converting the electrical signal back into an optical signal. Additionally, the prior art includes switches that mechanically move mirrors to cause a change in the light signal's direction of propagation. Further, the prior art includes optical switches that use lasers to heat a fluid in the vicinity of a bend in a waveguide. When the fluid is heated its index of refraction is reduced and the light rays incident of the bend are totally internally reflected causing a shift in the light rays direction of propagation. However, none of the prior optical switches provide the desired low cost, high speed, low energy consuming, high reliability optical switch. Accordingly, it is an object of the present invention to provide such an optical switch.

### SUMMARY OF THE INVENTION

The present invention provides a low cost, high speed, low energy consuming, high reliability optical switch that is comprised of a plasma field.

### BRIEF DESCRIPTION OF THE FIGURES

FIG. 1a is a diagram of the first embodiment of the present invention in its non-switched configuration.

FIG. 1b is a diagram of the first embodiment of the present invention in its switched configuration.

FIG. 2a is a diagram of the second embodiment of the present invention in its non-switched configuration.

FIG. 2b is a diagram of the second embodiment of the present invention in its switched configuration.

FIG. 3 is a diagram depicting an alternative version of the second embodiment.

### DETAILED DESCRIPTION

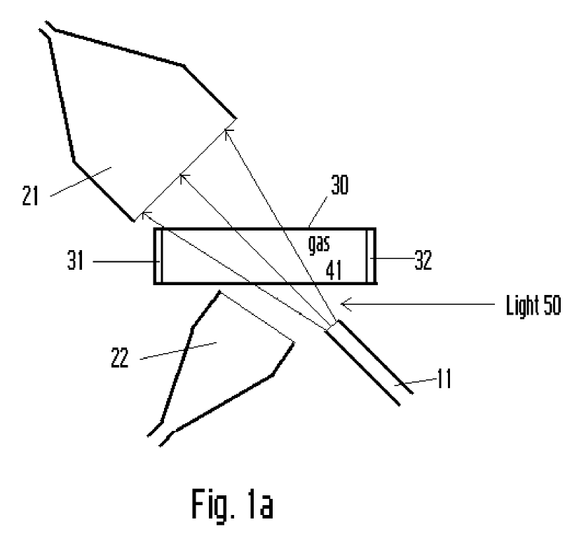

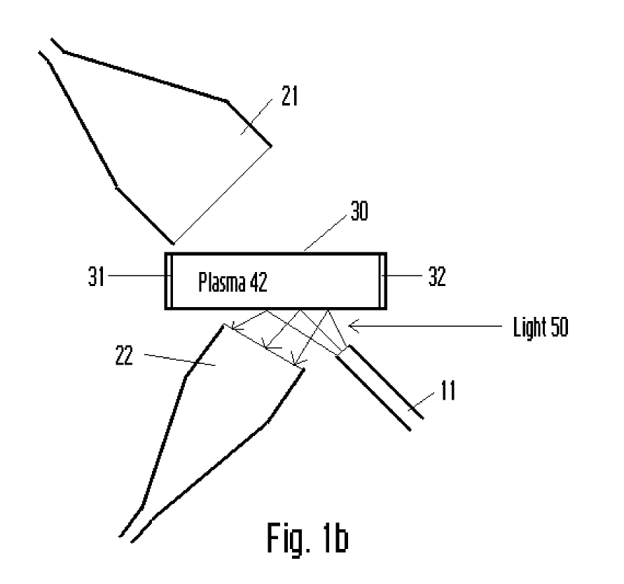

A first embodiment of an optical switch according to the present invention is shown in FIGS. 1a and 1b. The switch is comprised of inlet port 11, non-switched outlet port 21, switched outlet port 22, plasma chamber 30, positive electrode 31, negative electrode 32, gas 41, plasma 42, and light signal 50.

Inlet port 11, non-switched outlet port 21, and switched outlet port 22 are optical waveguides. Plasma chamber 30 has a rectangular cross section and it is elongated in the dimension perpendicular to FIG. 1. Positive electrode 31 and negative electrode 32 are positioned at opposing ends of plasma chamber 31. Gas 41 is an inert gas that is transparent to light 50. When a sufficient potential is applied across plasma chamber 30, an electron current flows from negative electrode 32 to positive electrode 31 causing plasma 42 to form within plasma chamber 30. Plasma 42 is comprised of gas 41, electrons, and ions. Light signal 50 is comprised of photons capable of being transmitted by said waveguides.

The present invention relies upon the fact that the index of refraction of plasma 42 is less than the index of refraction of gas 41. Although the precise complex index of refraction of light in a plasma is dependant upon several factors, including the magnetic field in which the plasma resides and the number of collisions between the light and the plasma, for most embodiments of the present invention the index of refraction can be determined using Equation 1 below.
n²=E=1−(Ne²)/(E₀mw²) Equation 1
n is the index of refraction of the plasma.
E is the dielectric constant for the plasma.
N is the electron density of the plasma.
e is the electron charge.
E₀ is the dielectric constant in free space.
m is the mass of an electron.
w is the frequency of the light passing through the plasma.

Accordingly, the index of refraction for light passing through a plasma field is always less than 1 (provided that no magnetic field is present) and it is dependant upon the electron density and upon the frequency of the light. Additionally, if the electron density is sufficiently high for a given electromagnetic wave frequency, the dielectric constant will be negative and the index of refraction will be purely imaginary.

In general, when a light ray is incident upon a boundary between a first transparent material and a second transparent material that has different index of refraction than the first material, a small amount of the light will be reflected back into the first material and the remainder of the light will be transmitted through the second material. According to Snell's Law, the angle of refraction Ø₂, which describes the direction of propagation of the light being transmitted through the second material is dependant upon the angle of incidence Ø₁ of the light ray as measured with respect to a line normal to the boundary and it is dependant upon the ratio of the first material's index of refraction n₁ to the second material's index of refraction n₂. Snell's Law can be expressed by Equation 2 below.
nᵢ Sin(Ø₁)=n₂ Sin(Ø₂) Equation 2.

Additionally, the angle of reflection Ø₃ in the first material is equal to the angle of incidence Ø₁. If the angle of refraction Ø₂ is greater than or equal to 90 degrees, the entire light ray is reflected and no light is transmitted through the second material. This phenomenon is known as total internal reflection, which is the same principle according which waveguides function. Accordingly, light with an angle of incidence Ø₁ greater than the inverse sine of the second material's index of refraction n₂ divided by the first material's index of refraction n₁ will be totally internally reflected (Total internal reflection occurs if Ø₁>inv sin(n₁/n₂)).

As shown by equations 1 and 2, if light at a specific frequency and at a specific angle is incident upon a plasma field, the light will be totally internally reflected if the electron density of the plasma is sufficiently high with respect to the frequency of the incident light. Additionally, if the electron density is sufficiently high such that the index of refraction is entirely imaginary, the light will be totally internally reflected for all angles of incidence

FIG. 1a shows the optical switch in its non-switched configuration. In the non-switched configuration, the voltage gradient across plasma chamber 30, as determined by the voltages applied to positive electrode 31 and negative electrode 32, is not sufficient to cause an electron current to flow through plasma chamber 31 and no plasma field is generated. Accordingly, light 50 is transmitted from inlet port 11 to non-switched outlet port 21 through gas 41. When light 50 exits inlet port 11, it diverges as a cone, where the sine of the vertex angle of the cone is no greater than the numerical aperture of inlet port 11. Accordingly, the input radius of non-switched outlet port 21 is greater than the output radius of input port 111 by an amount sufficient to account for said divergence. However, the radius of non-switched outlet port 21 gradually decreases to equal the radius of the waveguides to which the switch is connected.

FIG. 1b shows the optical switch in its switched configuration. In the switched configuration, the voltage gradient across plasma chamber 30, as determined by the voltages applied to positive electrode 31 and negative electrode 32, is sufficient to cause an electron current to flow through plasma chamber 30 thereby generating plasma 42 in plasma chamber 30. After initial plasma generation, the current flow through plasma chamber 31 is regulated to maintain the appropriate electron density to ensure that all of the light rays that comprise light 50 are reflected by plasma 42. Accordingly, light 50 is transmitted from inlet port 11 to non-switched outlet port 21. When light 50 exits inlet port 11, it diverges as a cone, where the sine of the vertex angle of the cone is no greater than the numerical aperture of inlet port 11. Accordingly, the input radius of switched outlet port 22 is greater than the output radius of input port 111 by an amount sufficient to account for said divergence.

The optical switch of this first embodiment is operated by controlling the voltage applied to positive electrode 31 and negative electrode 32 and by controlling the current flow through plasma chamber 30. After initial plasma generation, the electrical resistance across plasma chamber 30 is substantially reduced. Hence, the voltage across the chamber is also reduced. Accordingly, the turn off voltage for the chamber is less than the turn on voltage. In an alternative version of the first embodiment, plasma 41 could be generated through the use of a laser or other appropriate means. Additionally, instead of relying on reflection to switch light 50, plasma 41's index of refraction could be manipulated to change the path of light traveling through it.

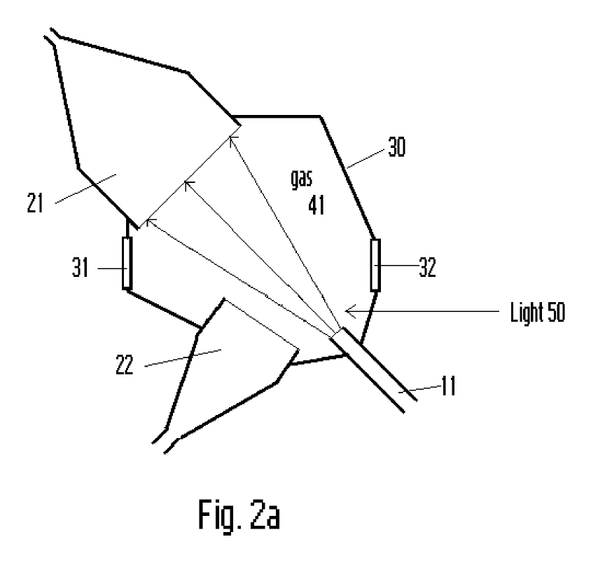

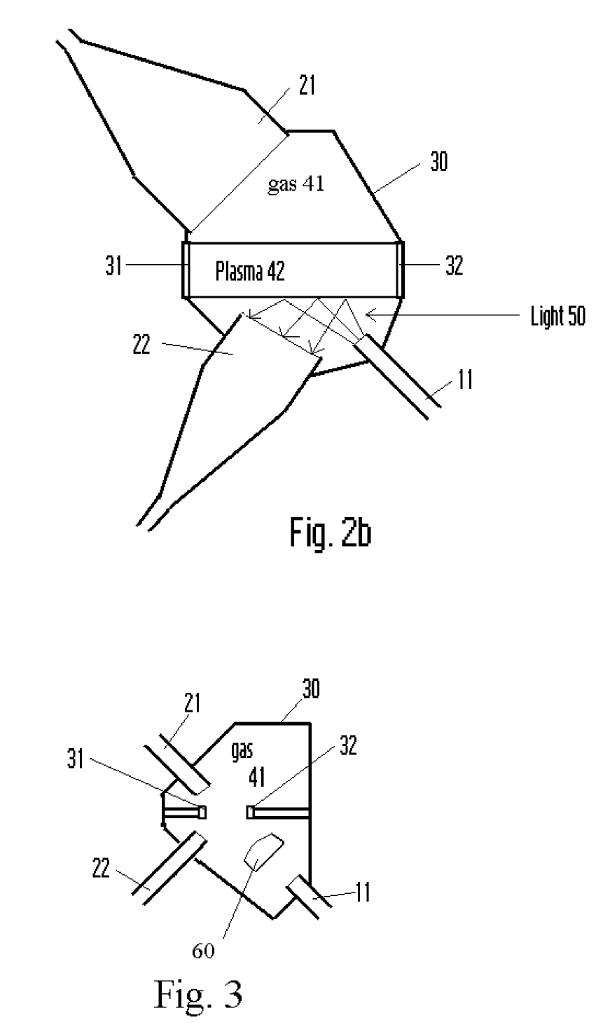

A second embodiment is shown in FIG. 2. As shown in FIGS. 2a and 2b, plasma chamber 31 is expanded such that inlet port 11, non-switched outlet port 21, and switched outlet port 22 are within the plasma chamber 30. Positive electrode 31 and negative electrode 32 are configured such that plasma 41 is shaped into a plasma field having a planar lower surface. Additionally, magnetic fields can be applied to help shape the plasma field, although the effect of the magnetic field on the index of refraction would have to be taken into account.

As shown in FIG. 3, lens 60 could be added to the second embodiment. Lens 60 eliminates the need for expanded inlet diameters on the outlet ports and it allows for a smaller distance between positive electrode 31 and negative electrode 32, which provides for a faster response time. However, if laser light is being used, it may be desirable to forego both lens 60 and the expanded inlet diameters for the outlet ports.

As will be appreciated by those skilled in the art, the present invention is not limited to the disclosed embodiments and the appended claims should not be so construed. Additionally, the use of the terms light and optical switch should not be construed to limit the claimed invention to the visible spectrum.

What is claimed is:

1. An optical switch comprising:
a plasma field.

2. The switch of claim 1 wherein:
said plasma field is generated electronically.

3. The switch of claim 2 further comprising:
a positive electrode; and
a negative electrode.

4. The switch of claim 1 further comprising:
an inlet port; and
a plurality of outlet ports.

5. The switch of claim 4 further comprising:
a plasma chamber.

6. The switch of claim 5 wherein:
said inlet port and said plurality of outlet ports are contained within said plasma chamber.

7. The switch of claim 1 wherein:
said plasma field is generated by a laser.

8. The switch of claim 1 wherein:
a light signal is reflected by said plasma field.

9. The switch of claim 1 further wherein:
The electron density of the plasma field is varied to alter the path of a light signal through the plasma field.

10. An optical switch comprising:
a gas; and
a means for generating a plasma field in said gas.

11. The optical switch of claim 10 further comprising:
an inlet port; and
an outlet port.

12. The optical switch of claim 10 further comprising:
a lens.
